(19) United States
(12) Patent Application Publication
(10) Pub. No.: US 2019/0300121 A1
(43) Pub. Date: Oct. 3, 2019

(54) SADDLE-TYPE VEHICLE

(71) Applicant: HONDA MOTOR CO., LTD., Tokyo (JP)

(72) Inventor: Chiaki Yamamoto, Wako-shi (JP)

(21) Appl. No.: 16/369,400

(22) Filed: Mar. 29, 2019

(30) Foreign Application Priority Data
Mar. 30, 2018 (JP) 2018-069178

(51) Int. Cl. B62M 25/08; B62J 99/00; B62K 23/06; B62J 6/16

(52) U.S. Cl. CPC B62M 25/08; B62J 99/00; B62K 23/06; B62J 6/005; B62J 2099/002; B62J 2099/0026; B62J 6/16

(57) ABSTRACT

When a rider of a motorcycle has manipulated a shift manipulation member, a shift stroke sensor detects an expansion/contraction amount corresponding to a load placed on the shift manipulation member. A controller of an ECU references a map and, when the load corresponding to the expansion/contraction stroke amount exceeds a threshold value point (down-side ON point one up-side ON point), switches a transmission stage of a transmission. The threshold value point can be changed based on a manipulation of an instruction switch by the driver while the motorcycle is travelling.

### CROSS-REFERENCE TO RELATED APPLICATION

This application is based upon and claims the benefit of priority from Japanese Patent Application No. 2018-069178 filed on Mar. 30, 2018, the contents of which are incorporated herein by reference.

### BACKGROUND OF THE INVENTION

### Field of the Invention

The present invention relates to a saddle-type vehicle in which the transmission gear is switched when the load applied to a shift manipulation member by a manipulation made by a rider exceeds a threshold value, without the clutch being manipulated.

### Description of the Related Art

Japanese Laid-Open Patent Publication No. 2017-129219 discloses a saddle-type vehicle including a shift stroke sensor that detects an expansion/contraction stroke amount of a lost motion mechanism interposed in a shift manipulation member manipulated by a driver (rider), and a spindle sensor that detects pivoting of a shift spindle that operates according to manipulation of the shift manipulation member. In this case, an ECU of the saddle-type vehicle converts the expansion/contraction stroke amount detected by the shift stroke sensor into a load, and judges that an up-shift manipulation or a down-shift manipulation was performed when the converted load exceeds a threshold value. A shift assist function is executed to perform a shift operation, without the clutch being manipulated.

### SUMMARY OF THE INVENTION

However, in the technology of Japanese Laid-Open Patent Publication No. 2017-129219, only one threshold value (ON point on the up side and ON point on the down side) is set for both the up-shift side and the down-shift side (see FIG. 8 of Japanese Laid-Open Patent Publication No. 2017-129219). Therefore, there are cases where a shift operation in accordance with the feeling of the manipulation by the driver cannot be performed while the saddle-type vehicle is travelling.

Therefore, it is an object of the present invention to provide a saddle-type vehicle capable of performing the gear shift operation in accordance with the manipulation feeling of the driver (rider).

The present invention is a saddle-type vehicle comprising a shift manipulation member that is manipulated by a rider; a load sensor that detects a load placed on the shift manipulation member by the manipulation made by the rider; a transmission; and a control apparatus that switches a transmission stage of the transmission when the load detected by the load sensor exceeds a threshold value, without a clutch being manipulated, and has the following features.

First Feature: The control apparatus is capable of changing the threshold value for an up-shift or a down-shift to a plurality of values, while the saddle-type vehicle is travelling.

Second Feature: The saddle-type vehicle further comprises an instruction switch that instructs the control apparatus to change the threshold value, based on a manipulation made by the rider, while the saddle-type vehicle is travelling.

Third Feature: The saddle-type vehicle further comprises a display apparatus that displays a state of the saddle-type vehicle, including the change of the threshold value.

Fourth Feature: The control apparatus is capable of changing the threshold value for the up-shift side or the down-shift side to at least two values. At least one value, among the two values for at least one of the up-shift and the down-shift, is set to a value exceeding a load range used by the control apparatus to judge switching of the transmission stage.

Fifth Feature: The saddle-type vehicle further comprises a handle that extends to left and right sides of the saddle-type vehicle, on a front side of the saddle-type vehicle; a clutch lever that is arranged on one end side of the handle and connects or disconnects the clutch according to a manipulation by the rider; a blinker switch that is arranged on the one end side of the handle and causes a blinker provided to the saddle-type vehicle to blink according to a manipulation made by the rider, wherein, for the down-shift, at least one of the two values is set to a value exceeding the load range.

According to the first feature of the present invention, it is possible to adjust the threshold values for the up-shift side or the down-shift side in a staggered manner. Therefore, it is possible to realize a shift assist function that performs a shift operation in accordance with the feeling of the manipulation by the driver (rider) while travelling. Furthermore, by performing the staggered adjustment of the threshold value points while the saddle-type vehicle is travelling or stopped, it is possible to stop the detection function of the load sensor when conditions differ from when the adjustment was performed (while stopped if the adjustment was performed while travelling, or while travelling if the adjustment was made while stopped), for example. Yet further, by performing the shift assist function, it is possible to attempt to reduce the burden of the driver manipulating the saddle-type vehicle while travelling.

According to the second feature of the present invention, it is possible to adjust the threshold values to the rider's preference, and therefore it is possible to reliably perform the shift operation in accordance with the feeling of manipulation by the rider.

According to the third feature of the present invention, it is possible to easily check the state of the saddle-type vehicle, including changes of the threshold value points.

According to the fourth feature of the present invention, it is possible to adjust the threshold values for the up-shift or the down-shift in a staggered manner. Therefore, it is possible to realize a shift assist function that performs a shift operation in accordance with the feeling of the manipulation by the rider. Furthermore, by setting one of the two threshold value points for at least one of the up-shift and the down-shift to be a value outside the load range for judging whether to switch the transmission stage, it is possible for the shift operation to not be performed if the clutch lever is not manipulated. For example, for the down-shift, it is easy to manipulate the shift manipulation member, and therefore it is envisioned that the rider will manipulate the shift manipulation member more than necessary. Therefore, by setting the threshold value points to be values that exceed the threshold values, it is possible to avoid execution of the shift assist function that would accompany such an erroneous manipulation.

According to the fifth feature of the present invention, it is possible to perform the shift operation in accordance with deceleration of the saddle-type vehicle, when in an urban area or turning left or right at an intersection.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a left-side view of a motorcycle according to the present embodiment;

FIG. 2 is a left-side view of a region around the transmission in the motorcycle of FIG. 1;

FIG. 3 is a left-side view of the inside of the crank case of FIG. 2;

FIG. 4 is a block diagram relating to the shift assist function; and

FIG. 5 shows the relationship between the expansion/contraction stroke amount and the load.

### DESCRIPTION OF THE PREFERRED EMBODIMENTS

A saddle-type vehicle according to the present invention will be explained in detail below based on a preferred embodiment with reference to the accompanying drawings.

### [1. Schematic Configuration of the Motorcycle 10]

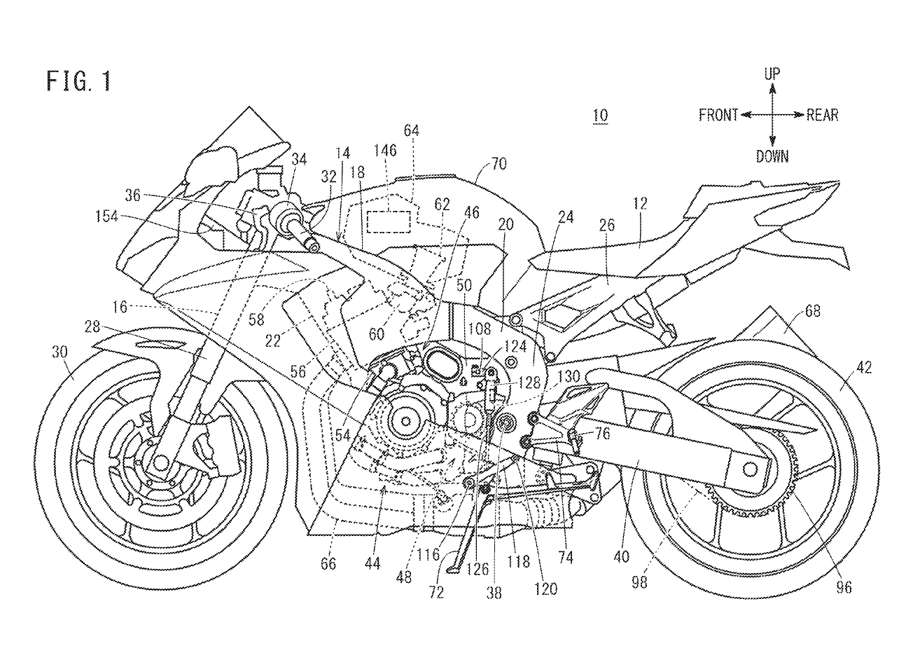

FIG. 1 is a left-side view of a motorcycle 10 serving as the saddle-type vehicle according to the present embodiment. In the following description, the directions of front and back, left and right, and up and down are described as seen by a driver (rider) sitting on a seat 12 of the motorcycle 10.

The motorcycle 10 includes a vehicle frame 14. The vehicle frame 14 includes a head pipe portion 16 at the front end portion, a pair of main frames 18 that are separated to the left and right and extend rearward from the head pipe portion 16, and center frames 20 that are connected to the rear ends of the left-right pair of main frames 18 and extend curving downward. The main frames 18 include a down frame portion 22. Furthermore, the portion of the left-side center frame 20 extending downward forms a rear fork pivot portion 24. Yet further, a seat rail 26 is provided extending diagonally upward and rearward from the curved portions of the left-right pair of center frames 20.

The head pipe portion 16 supports a left-right pair of front forks 28 in a steerable manner. A front wheel 30 is axially supported at the bottom ends of the front forks 28. A steering handle 32 is connected to the top ends of the front forks 28. A handle switch 34 on which a plurality of switches are arranged and a clutch lever 36 are arranged on the left side of the steering handle 32.

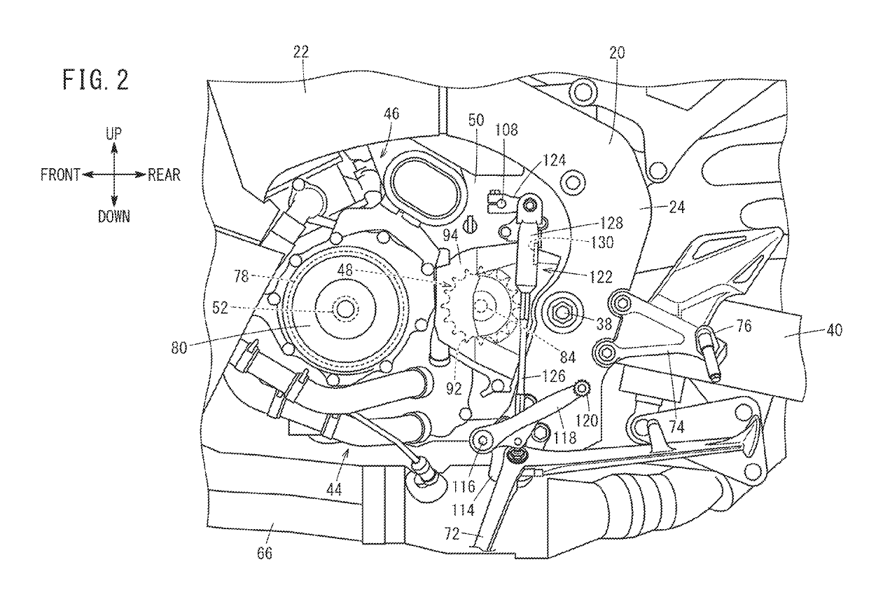

As shown in FIGS. 1 and 2, a pivot shaft 38 is arranged on the rear fork pivot portion 24, and a front end of a rear fork 40 is axially supported by the pivot shaft 38. The rear fork 40 extends rearward from the pivot shaft 38, and a rear wheel 42 is axially supported in a manner to swing up and down at the rear end of the rear fork 40.

A power unit 44 serving as the drive source of the motorcycle 10 is mounted on the vehicle frame 14. The power unit 44 hangs from the down frame portion 22 and the center frames 20, and includes an engine 46 and a transmission 48. In this case, the transmission 48 is housed in the rear portion inside a crank case 50 of the engine 46. The transmission 48 is a manual shifting type of multistage transmission.

The engine 46 is a water-cooled 4-cylinder 4-stroke cycle engine, and is mounted on the motorcycle 10 such that a crank shaft 52 is oriented in a vehicle width direction (left-right direction). A cylinder block 54 and a cylinder head 56 are connected in an upright position in a sequentially stacked manner, with the cylinder axis slightly inclined forward, above the crank case 50 that axially supports the crank shaft 52 in a rotatable manner. A cylinder cover 58 covers the top end of the cylinder head 56.

An air intake pipe 62 extends upward from the cylinder head 56 via a throttle body 60, and an air cleaner 64 is connected thereto. Furthermore, an exhaust pipe 66 extends forward from the cylinder head 56. The exhaust pipe 66 curves downward, and extends farther rearward such that the rear portion thereof is connected to a muffler 68.

The fuel tank 70 hangs from the main frames 18 and the center frames 20 above the power unit 44. The seat 12 on which the rider sits is supported on the seat rail 26 behind the fuel tank 70. A side stand 72 is mounted in a pivotable manner on the bottom end of the left-side center frame 20. The front end of a support bracket 74 is fixed behind the pivot shaft 38 of the rear fork 40 on the center frame 20. The support bracket 74 protrudes to the rear, and a back step 76 on which the driver places the feet extends outward in the vehicle width direction.

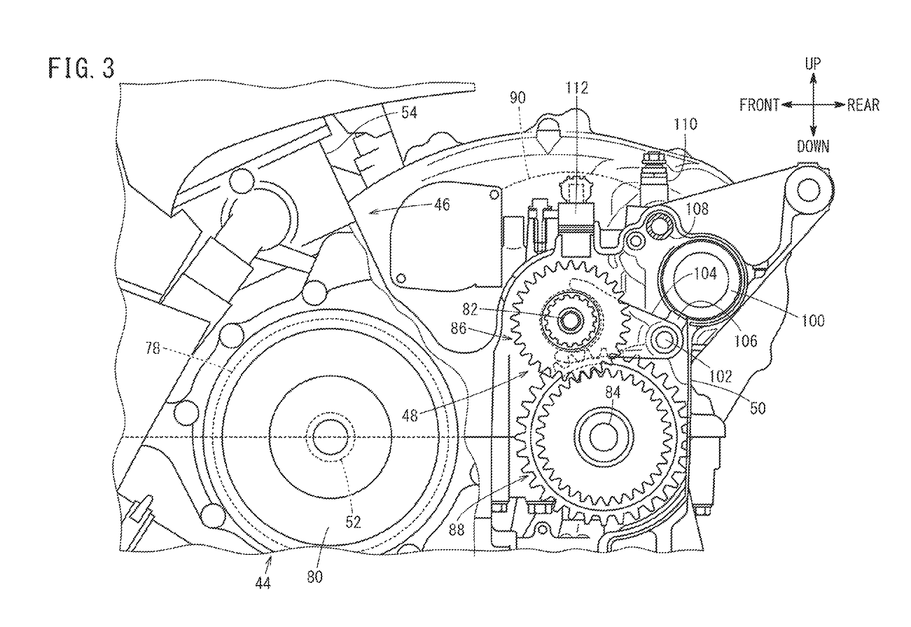

As shown in FIGS. 2 and 3, an AC generator 78 is provided inside the crank case 50 on the left end of the crank shaft 52. The AC generator 78 protruding to the left is covered by an ACG cover 80 from the left side.

The counter shaft 84 and the main shaft 82 of the transmission 48 extend in the left-right direction at the rear inside the crank case 50. The main shaft 82 is positioned slightly forward above the counter shaft 84. In the transmission 48, a transmission drive gear 86 (drive gear group) axially supported on the main shaft 82 and a transmission driven gear 88 (driven gear group) axially supported on the counter shaft 84 are constantly engaged for every gear ratio.

A transmission clutch 90 is provided on the right end of the main shaft 82. The transmission clutch 90 is covered by a clutch cover (not shown in the drawings) from the right side. A clutch operation portion is provided on the clutch cover, and transmission clutch 90 can be operated based on the manipulation of the clutch lever 36 by the driver.

As shown in FIGS. 1 to 3, the counter shaft 84 is an output shaft of the power unit 44, and penetrates through a bearing on the left side of the crank case 50 to protrude to the left. An output sprocket 92 is engaged on the left end of the counter shaft 84. The output sprocket 92 is arranged near the pivot shaft 38, and is covered from the left side by an output sprocket cover 94. A drive chain 98 is wound between the output sprocket 92 and a driven sprocket 96 that is engaged with the shaft of the rear wheel 42. The motorcycle 10 travels by having the output of the power unit 44 transmitted to the rear wheel 42 via the drive chain 98.

A shift drum 100 is arranged diagonally upward and rearward from the main shaft 82 and the counter shaft 84. A shift fork shaft 102 is provided parallel to the main shaft 82 and the counter shaft 84, between the shift drum 100 and the transmission driven gear 88. A shift fork 104 is axially supported to be slidable in the left-right direction on the shift fork shaft 102.

The shift fork 104 is slidably engaged with a lead groove of the shift drum 100 by the engagement pin 106, such that the bifurcated fork portion is slidably supported on the main shaft 82 and the counter shaft 84 to engage with a shifter gear. When the shift drum 100 rotates, the shift fork 104 moving in the axial direction is guided by the lead groove of the shift drum 100 to move the shifter gear, and engages with the dog clutch of the shifter gear. As a result, the engagement of the transmission gear pair of the main shaft 82 and the counter shaft 84 is effective, and a single transmission stage is established.

The shift spindle 108 extends in the left-right direction diagonally above and in front of the shift drum 100. The shift spindle 108 is arranged to be axially supported in a rotatable manner inside the crank case 50. A shift drum drive mechanism (not shown in the drawings) that intermittently rotates the shift drum 100 is provided on the right end of the shift spindle 108.

A shift spindle sensor 110 is provided above the shift spindle 108. The shift spindle sensor 110 is in the ON state when the shift spindle 108 is at the usual rotational position without a shift manipulation being performed, and is in the OFF state when the shift spindle 108 is rotated by the shift manipulation. In other words, the shift spindle sensor 110 detects the presence or lack of a shift manipulation, by detecting rotation of the shift spindle 108. Furthermore, a rotational speed sensor 112 that detects the rotational speed of the main shaft 82, by detecting the rotation of the teeth of the transmission drive gear 86, is provided near the shift spindle sensor 110.

The support bracket 114 is secured to the bottom end portion of the left-side center frame 20, below the left end portion of the shift spindle 108. A shift support shaft 116 is provided protruding from the support bracket 114, and a shift manipulation member 118 is axially supported on the shift support shaft 116. The shift manipulation member 118 is a manipulation lever extending rearward from the front end thereof and axially supported on the shift support shaft 116. A shift pedal 120 that protrudes to the left is provided on the rear end of the shift manipulation member 118.

The shift manipulation member 118 is joined to the shift spindle 108, via a link mechanism 122. Specifically, the link mechanism 122 includes a shift arm 124 engaged with the left end portion of the shift spindle 108 and a shift rod member 126 that extends in the up-down direction and joins together the shift arm 124 and the shift manipulation member 118.

A lost motion mechanism 128 that transmits manipulation force of the shift manipulation member 118 (load placed on the shift manipulation member 118) by the driver, using an elastic member, is interposed in the shift rod member 126. The lost motion mechanism 128 is provided to absorb the shock occurring at every dog of the dog clutch of the transmission 48, to realize a favorable shift manipulation feeling. A shift stroke sensor (load sensor) 130 that detects the expansion/contraction stroke amount (stroke amount corresponding to the load placed on the shift manipulation member 118) of the shift rod member 126, which expands and contracts due to the lost motion mechanism 128, is attached to the lost motion mechanism 128.

The lost motion mechanism 128 is a structure that expands and contracts due to a coil spring interposed between the top side portion and the bottom side portion thereof, and the shift stroke sensor 130 is a linear displacement sensor that detects the relative movement distance (expansion/contraction stroke amount) of the top side portion and the bottom side portion.

The back step 76 is provided in a protruding manner above and behind a shift pedal 120. When the left foot of the driver sitting on the seat 12 is placed on the back step 76 and the driver kicks downward on the shift pedal 120 with the tip of the foot, the shift manipulation member 118 swings upward. Due to this, the shift rod member 126 is pressed up and the shift arm 124 swings upward. As a result, the shift spindle 108 engaged with the shift arm 124 rotates counter-clockwise, in the left-side views of FIGS. 1 to 3. The rotation of the shift spindle 108 causes the shift drum 100 to rotate via the shift drum drive mechanism, and up-shifts the transmission stage of the transmission 48. In other words, the driver can perform the up-shift manipulation by swinging the shift manipulation member 118 upward.

On the other hand, when the driver steps down on the shift pedal 120 with the tip of the foot, the shift manipulation member 118 swings downward. Due to this, the shift rod member 126 is pulled downward and the shift arm 124 swings downward. As a result, the shift spindle 108 engaged with the shift arm 124 rotates clockwise, in the left-side views of FIGS. 1 to 3. The rotation of the shift spindle 108 causes the shift drum 100 to rotate via the shift drum drive mechanism, and down-shifts the shift state of the transmission 48. In other words, the driver can perform the down-shift manipulation by swinging the shift manipulation member 118 downward.

When the shift manipulation member 118 is swung and the shift rod member 126 is raised up or pulled down in accordance with such a shift manipulation, the coil spring of the lost motion mechanism 128 expands or contracts, and therefore it is possible to detect this expansion/contraction stroke amount with the shift stroke sensor 130. Furthermore, when the shift spindle 108 rotates via the link mechanism 122 due to the shift manipulation, the shift spindle sensor 110 is turned ON/OFF and it is possible to detect completion of the shift change (confirm the transmission stage).

[2. Shift Assist Function of the Motorcycle 10 according to the Present Embodiment]

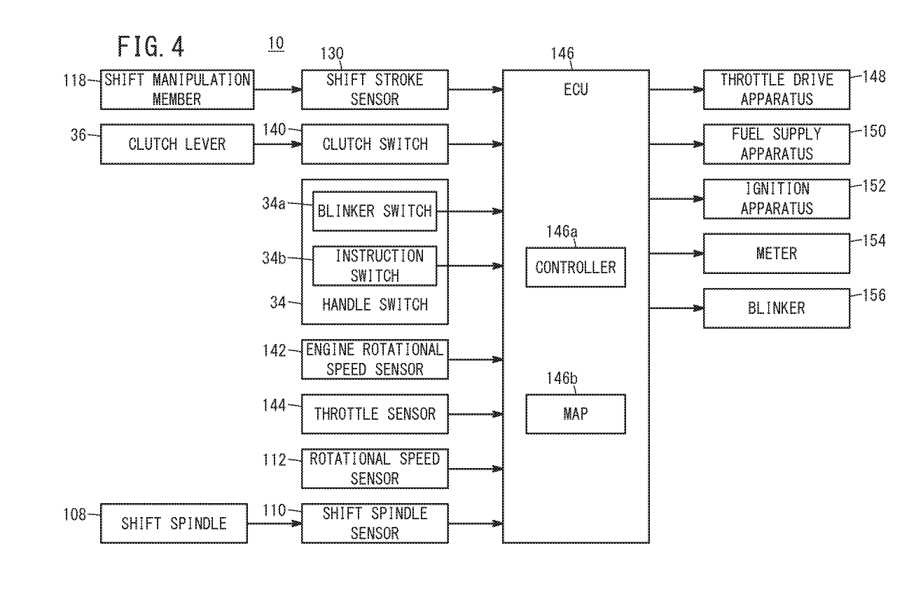

With the motorcycle 10 according to the present embodiment, when the load placed on the shift manipulation member 118, which corresponds to the expansion/contraction stroke amount detected by the shift stroke sensor 130, exceeds a threshold value (the down-side ON point or up-side ON point described further below), it is judged that an up-shift or down-shift manipulation has been performed, and the shift assist function for performing the shift operation is executed based on this judgment result, without the manipulation of the clutch lever 36 being performed by the driver. FIG. 4 is a block diagram relating to the shift assist function of the motorcycle 10.

The motorcycle 10 includes, in addition to the handle switch 34, the clutch lever 36, the shift spindle 108, the shift spindle sensor 110, the shift manipulation member 118, and the shift stroke sensor 130 described above, a clutch switch 140, an engine rotational speed sensor 142, a throttle sensor 144, an ECU (control apparatus) 146, a throttle drive apparatus 148, a fuel supply apparatus 150, an ignition apparatus 152, a meter 154, and a blinker 156.

The clutch switch 140 is a limit switch that is turned ON/OFF by the manipulation of the clutch lever 36 by the driver. The handle switch 34 includes a blinker switch 34a and various instruction switches 34b. The blinker switch 34a is a manipulation switch for instructing the blinker 156 to flash, by being manipulated by the driver. The instruction switches 34b are manipulation switches for providing various instructions to the ECU 146 by being manipulated by the driver. The engine rotational speed sensor 142 detects the engine rotational speed of the engine 46, and outputs this engine rotational speed to the ECU 146. The throttle sensor 144 detects the degree of opening of the throttle or the manipulation amount of the throttle grip (not shown in the drawings) by the driver, and outputs this detection result to the ECU 146.

The ECU 146 is an electronic control unit such as an engine control apparatus provided to the motorcycle 10, and realizes the function of a controller 146a by executing a program stored in a memory (not shown in the drawings). Furthermore, a map 146b referenced by the controller 146a is also stored in the memory of the ECU 146.

Various detection results and pieces of information are input to the ECU 146 from the shift spindle sensor 110, the rotational speed sensor 112, the handle switch 34 (blinker switch 34a and instruction switches 34b), the shift stroke sensor 130, the clutch switch 140, the engine rotational speed sensor 142, and the throttle sensor 144. The controller 146a controls the throttle drive apparatus 148, the fuel supply apparatus 150, and the ignition apparatus 152, displays various pieces of information in the meter 154, or causes the blinker 156 to flash, based on the detection results and information input thereto.

Specifically, the controller 146a adjusts the opening degree of the throttle by controlling the throttle drive apparatus 148. Furthermore, the controller 146a adjusts the amount of fuel supplied to the engine 46 from the fuel tank 70, by controlling the fuel supply apparatus 150. The controller 146a adjusts the ignition time by controlling the ignition apparatus 152. The controller 146a displays various pieces of information, such as the engine rotational speed detected by the engine rotational speed sensor 142, in the meter 154. The controller 146a causes the blinker 156 to flash when the driver has manipulated the blinker switch 34a.

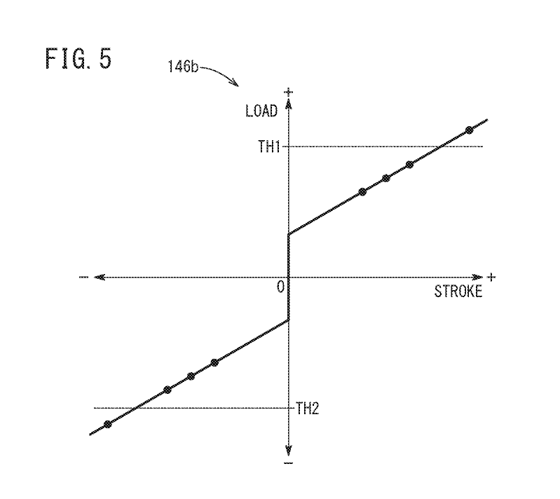

As shown in FIG. 5, the map 146b shows the relationship between the expansion/contraction stroke amount of the shift rod member 126 and the magnitude of the load placed on the shift manipulation member 118. The positive direction of the expansion/contraction stroke amount on the horizontal axis indicates the positive stroke amount when down-shifting, and the negative direction indicates the negative stroke amount when up-shifting. Furthermore, the positive direction on the vertical axis indicates a positive load (expansion load), and the negative direction indicates a negative load (contraction load).

The controller 146a converts the expansion/contraction stroke amount detected by the shift stroke sensor 130 into the load placed on the shift manipulation member 118, based on the solid characteristic line in the map 146b.

In this case, a plurality of threshold value points (referred to below as down-side ON points) indicated by black circles are provided on the positive side on the solid line of the map 146b, and a plurality of threshold value points (referred to below as up-side ON points) indicated by black circles are provided on the negative side on the solid line of the map 146b.

Each down-side ON point is a judgment reference point for judging that a down-shift manipulation has been performed with the shift manipulation member 118, when an expansion/contraction stroke amount exceeding this threshold value is input to the ECU 146. Accordingly, when an expansion/contraction stroke amount that is smaller than the expansion/contraction stroke amount of a down-side ON point is input to the ECU 146, the controller 146a judges that the down-shift manipulation has not been performed.

On the other hand, each up-side ON point is a judgment reference point for judging that an up-shift manipulation has been performed with the shift manipulation member 118, when an expansion/contraction stroke amount exceeding this threshold value is input to the ECU 146. Accordingly, when an expansion/contraction stroke amount that is smaller than the expansion/contraction stroke amount of an up-side ON point is input to the ECU 146, the controller 146a judges that the up-shift manipulation has not been performed.

In this case, by having the driver manipulate the instruction switches 34b while the motorcycle 10 is travelling or stopped, one point among the plurality of down-side ON points is set as the down-side ON point serving as the judgment reference point for the down-shift manipulation, and one point among the plurality of up-side ON points is set as the up-side ON point serving as the judgment reference point for the up-shift manipulation. That is, in the map 146b, the driver can select the down-side ON point or the up-side ON point as desired as long as there are at least two down-side ON points and at least two up-side ON points.

The controller 146a judges whether an up-shift manipulation or down-shift manipulation has been performed, using the set one down-side ON point and one up-side ON point as the judgement reference points. Accordingly, it is possible to suitably change the down-side ON point and the up-side ON point every time the driver manipulates an instruction switch 34b while the motorcycle 10 is travelling or stopped. When the down-side ON point and/or the up-side ON point has been changed, the controller 146a displays the result of this change in the meter 154.

Here, when the actual load placed on the shift manipulation member 118 exceeds the load of the up-side ON point, the controller 146a judges that an up-shift manipulation has been performed, and controls the fuel supply apparatus 150 to perform a fuel injection cut to stop the supply of fuel and controls the ignition apparatus 152 to perform ignition retardation to delay the ignition time, thereby reducing the output of the engine 46. In this way, the output of the engine 46 is reduced, and therefore it is possible to smoothly release the dog clutch of the transmission 48 by reducing the transmitted torque and to switch the transmission stage (up-shift), without having the driver manipulate the clutch lever 36. Furthermore, since the shift spindle 108 rotates via the link mechanism 122 due to the up-shift manipulation, the shift spindle sensor 110 detects the rotation of the shift spindle 108 and outputs this detection result to the ECU 146.

On the other hand, when the actual load placed on the shift manipulation member 118 exceeds the load of the down-side ON point, the controller 146a judges that a down-shift manipulation has been performed, and switches the transmission stage (down-shift). In this case, by increasing the opening degree of the throttle, the engine rotational speed is increased and the output of the engine 46 is increased.

As shown by the dashed lines in FIG. 5, a threshold value TH1 is set for the positive-side load and a threshold value TH2 is set for the negative-side load, in the map 146b. In this case, among the plurality of down-side ON points, one down-side ON point is set in a region exceeding the threshold value TH1, and the remaining down-side ON points are set in a region smaller than the threshold value TH1. Furthermore, among the plurality of up-side ON points, one up-side ON point is set in a region exceeding the threshold value TH2, and the remaining up-side ON points are set in a region smaller than the threshold value TH2.

Here, if the down-side ON points and up-side ON points are within the range between the threshold values TH1 and TH2 (load range from TH1 to TH2), the controller 146a performs the judgment process for switching the transmission stage. On the other hand, if the down-side ON points and/or up-side ON points are outside the load range from TH1 to TH2, the controller 146a does not perform the judgment process for switching the transmission stage, even when a load exceeding the threshold value TH1 or TH2 is detected. Accordingly, even when a load exceeding the threshold value TH1 or TH2 acts on the shift manipulation member 118, the shift assist function is not performed.

In other words, as shown in FIG. 5, in a case where judgement reference points are set respectively for one down-side ON point that exceeds the threshold value TH1 and one up-side ON point that exceeds the threshold value TH2, even when a large expansion/contraction stroke amount is input to the ECU 146 from the shift stroke sensor 130, the controller 146a does not allow the transmission stage switch. In this case, the driver manipulates the clutch lever 36 to perform the transmission stage switch.

In the present embodiment, the threshold value for at least one of the one down-side ON point and the one up-side

ON point may be set to exceed the threshold value TH1 or TH2. In other words, one of the threshold value TH1 for the down-shift side and the threshold value TH2 for the up-shift side may be set.

### [3. Effects of the Present Embodiment]

As described above, with the motorcycle 10 according to the present embodiment, it is possible to adjust the threshold value points (down-side ON points and up-side ON points) for the up-shift side or the down-shift side in a staggered manner. Therefore, it is possible to realize a shift assist function that performs a shift operation in accordance with the feeling of the manipulation by the driver (rider) while travelling. Furthermore, by performing the staggered adjustment of the threshold value points while the motorcycle 10 is travelling or stopped, it is possible to stop the detection function of the shift stroke sensor 130 when conditions differ from when the adjustment was performed (while stopped if the adjustment was performed while travelling, or while travelling if the adjustment was made while stopped), for example. Yet further, by performing the shift assist function, it is possible to attempt to reduce the burden of the driver manipulating the motorcycle 10 while travelling.

The rider instructs the ECU 146 to change the threshold value points by manipulating the instruction switches 34b while the motorcycle 10 is travelling, and therefore it is possible to adjust the threshold values to the rider's preference. Therefore, it is possible to reliably perform the shift operation in accordance with the feeling of manipulation by the rider.

The state of the motorcycle 10, including changes of the threshold value points, is shown in the meter 154, and therefore the driver can easily check the state of the motorcycle 10, including changes of the threshold value points.

By setting one of the two threshold value points for at least one of the up-shift and the down-shift to be a value outside the load range (threshold values TH1 and TH2) for judging whether to switch the transmission stage, it is possible for the shift operation to not be performed if the clutch lever 36 is not manipulated. For example, for the down-shift, it is easy to manipulate the shift manipulation member 118, and therefore it is envisioned that the rider will manipulate the shift manipulation member 118 more than necessary. Therefore, by setting the threshold value points (down-side ON point and up-side ON point) to be values that exceed the threshold values TH1 and TH2, it is possible to avoid execution of the shift assist function that would accompany such an erroneous manipulation.

Furthermore, for the down-shift, if one of the threshold value points among the two threshold value points (down-side ON point and up-side ON point) is set to be a value exceeding the threshold value TH1 or TH2, it is possible to perform the shift operation in accordance with deceleration of the motorcycle 10, when in an urban area or turning left or right at an intersection.

While the preferred embodiments of the present invention have been described above, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

What is claimed is:

1. A saddle-type vehicle comprising:
a shift manipulation member that is manipulated by a rider;
a load sensor configured to detect a load placed on the shift manipulation member by a manipulation made by the rider;
a transmission; and
a control apparatus configured to switch a transmission stage of the transmission when the load detected by the load sensor exceeds a threshold value, without a clutch being manipulated, wherein
the control apparatus is capable of changing the threshold value for an up-shift or a down-shift to a plurality of values, while the saddle-type vehicle is travelling.

2. The saddle-type vehicle according to claim 1, further comprising:
an instruction switch configured to instruct the control apparatus to change the threshold value, based on a manipulation made by the rider, while the saddle-type vehicle is travelling.

3. The saddle-type vehicle according to claim 1, further comprising:
a display apparatus configured to display a state of the saddle-type vehicle, including a change of the threshold value.

4. A saddle-type vehicle comprising:
a shift manipulation member that is manipulated by a rider;
a load sensor configured to detect a load placed on the shift manipulation member by a manipulation made by the rider;
a transmission; and
a control apparatus configured to switch a transmission stage of the transmission when the load detected by the load sensor exceeds a threshold value, without a clutch being manipulated, wherein
the control apparatus is capable of changing the threshold value for an up-shift or a down-shift to at least two values, and
at least one value, among the two values for at least one of the up-shift and the down-shift, is set to a value exceeding a load range used by the control apparatus to judge switching of the transmission stage.

5. The saddle-type vehicle according to claim 4, further comprising:
a handle that extends to left and right sides of the saddle-type vehicle, on a front side of the saddle-type vehicle;
a clutch lever that is arranged on one end side of the handle and connects or disconnects the clutch according to a manipulation by the rider;
a blinker switch that is arranged on the one end side of the handle and causes a blinker provided to the saddle-type vehicle to blink according to a manipulation made by the rider, wherein
for the down-shift, at least one of the two values is set to a value exceeding the load range.
